(19) United States
(12) Patent Application Publication
(10) Pub. No.: US 2014/0289988 A1
(43) Pub. Date: Oct. 2, 2014

(54) Surface Wiper Arrangement

(71) Applicant: FLEXSYS, INC., Ann Arbor, MI (US)

(72) Inventors: Gregory F. Ervin, Garden City, MI (US); Sridhar Kota, Ann Arbor, MI (US)

(73) Assignee: FlexSys, Inc., Ann Arbor, MI (US)

(21) Appl. No.: 14/365,616

(22) PCT Filed: Dec. 13, 2012
(86) PCT No.: PCT/US12/69577

§ 371 Date: Jun. 13, 2014

Related U.S. Application Data
(60) Provisional application No. 61/570,113, filed on Dec. 13, 2011.

(51) Int. Cl. B60S 1/42

(52) U.S. Cl. CPC B60S 1/42
USPC 15/250.32

(57) ABSTRACT

A wiper has a wiper arm having first and second ends. A leaf spring urges the wiper arm and a compliant force distribution arrangement toward the surface, and a mounting arrangement couples the first end of the wiper arm and the leaf spring element to a source of motion. The wiper arm has a first end coupling the first end of the wiper arm member to a source of motion, and a compliant force distributor is coupled to the second end, having plural resilient beam members integrally formed with each other and adapted to engage a wiper blade. A wiper mount has a mounting element having a mounting portion coupled to a source of motion and a drive portion for engaging the wiper arm. The leaf spring element also has a mounting portion coupled to the source of motion, and has a drive portion for engaging the wiper arm.

### BACKGROUND OF THE INVENTION

1. Field of the Invention

This invention relates generally to arrangements for wiping a liquid from a surface, and more particularly, to a wiper arrangement that is biased against the surface to be wiped at the source of wiper motion.

2. Description of the Prior Art

Wiper arrangements, particularly for vehicle glass, typically are formed of metal and have a mounting portion that mounts onto a source of motion, such as a wiper motor post. The mounting portion is coupled to a wiper arm by a hinge, and the wiper arm is then coupled to a wiper blade support, and ultimately to a wiper blade. A helical spring that is coupled at one end thereof to the mounting portion and at a distal end to the wiper arm serves to urge the wiper arm toward the vehicle glass. The combination of the interconnecting hinge and the helical spring accommodate out-of-plane displacement of the wiper blade as it follows the non-planar contour of the vehicle glass.

The conventional coupling between the metal wiper arm and the wiper blade support is a latching arrangement that also functions as a hinge. In addition, the conventional wiper blade support typically is formed of hinged arms, whereby a conventional wiper arrangement will have five hinge joints.

In addition to mechanical complexity, conventional wiper arrangements suffer from stylistic shortcomings. Modern automobiles are stylistically incongruent with the mechanically complex presentation of conventional wipers. This is particularly true of rear window and other wiper arrangements that are not parked when not in use, and therefore are continuously visible.

There is, therefore, a need for a mechanically simpler wiper arrangement that conforms stylistically to modern principles of vehicle styling, while meeting the aerodynamic demands imposed by high air speeds.

### SUMMARY OF THE INVENTION

The foregoing is met by this invention which provides a wiper arrangement for a surface. The wiper arrangement includes a wiper arm member having first and second ends. A mounting arrangement disposed on the first end of the wiper arm for coupling the first end of the wiper arm member to a source of motion. A compliant wiper force distribution arrangement is coupled to the second end of the wiper arm member and has a plurality of resilient beam members that are integrally formed with each other. The plurality of resilient beam members are adapted to engage a wiper blade. In one embodiment, the wiper arm member and the compliant wiper force distribution arrangement are integrally formed. In a further embodiment, the compliant wiper force distribution arrangement is provided with a resilient beam member. In embodiments where a plurality of resilient beam members are provided, such plural resilient beam members are optionally configured as respective resilient triangles. In an advantageous embodiment, the wiper arm member and the mounting arrangement are integrally formed.

In a practicable embodiment of the invention the mounting arrangement is pivotally coupled to the first end of the wiper arm member so as to facilitate angular translation of the wiper arm member in directions away and toward the surface. This accommodates for translation of the wiper arrangement in response to variations in the contour of the surface that is to be wiped. In one embodiment, the mounting arrangement is formed of a metallic material.

In a highly advantageous embodiment of the invention, there is further provided a leaf spring element that is coupled at a first end thereof to the mounting arrangement for urging the compliant wiper force distribution arrangement in the direction of the surface. The leaf spring element engages at its first end with the mounting arrangement for urging the compliant wiper force distribution arrangement laterally across the surface. The leaf spring urges the compliant wiper force distribution arrangement in the direction of the surface with a force that had been predetermined in its magnitude in response to a resilience characteristic of the compliant wiper force distribution arrangement. In embodiments of the invention wherein the surface has a non-linear contour, the leaf spring element urges the compliant wiper force distribution arrangement in the direction of the surface with a force adequate to maintain contact between the compliant force distribution arrangement and the non-linear contour of the surface throughout a wipe cycle.

A fastener engages the wiper arm member to the source of motion. Moreover, the leaf spring element is biased toward the surface in response to engagement of the fastener with the source of motion. In one embodiment, the leaf spring element is configured to be accommodated within the wiper arm member.

In some embodiments of the invention, the compliant wiper force distribution arrangement is configured to apply a non-uniform force to the surface. The wiper arm member is provided with an elongated portion intermediate of the first and second ends, and there is further provided a hinge element for coupling the elongated portion to the first end. An actuatable locking element having locked and unlocked positions, is provided in some embodiments for preventing the elongated portion of the wiper arm member from being urged in a direction away from the surface when the actuatable lock is in the locked position.

In embodiments of the invention that are used for vehicles, the surface is a translucent surface of a vehicle, such as a windshield, a rear window, a headlight lens, etc.

In accordance with a further apparatus aspect of the invention, there is provided a wiper arrangement having a compliant wiper force distribution arrangement. The wiper arrangement includes a wiper arm member having first and second ends, and an intermediate portion disposed between the first and second ends. A leaf spring element urges the compliant wiper force distribution arrangement in the direction of the surface. Additionally, a mounting arrangement couples the first end of the wiper arm member and the leaf spring element to a source of motion.

In one embodiment of this further apparatus aspect, there is provided a compliant wiper force distribution arrangement that is coupled to the second end of the wiper arm member. The compliant wiper force distribution arrangement has a plurality of resilient beam members that are integrally formed with each other. The plurality of resilient beam members are adapted to engage a wiper blade. In a highly advantageous embodiment the compliant wiper force distribution arrangement is integrally formed with the wiper arm member.

There is further provided in some embodiments a decorative cover that is arranged to overlie first end of the wiper arm member and the source of motion. Such a cover affords a pleasing appearance that conforms to modern vehicle styling.

In accordance with a still further apparatus aspect of the invention, there is provided a wiper mounting arrangement for a wiper having an elongated wiper arm. The wiper mounting arrangement includes a mounting element having a mounting portion thereof adapted for coupling to a source of wiper motion and a drive portion for engaging the elongated wiper arm. Additionally, a leaf spring element is provided having a mounting portion thereof adapted for coupling to a source of wiper motion and a drive portion that engages the elongated wiper arm.

In one embodiment of this apparatus aspect, the mounting element is configured to engage the leaf spring element to preclude relative motion in the direction of the wiper motion. This is achieved, in some embodiments, by providing the mounting element with a key portion. The leaf spring element is provided with a corresponding key way portion, or a flattened portion, that is configured to engage that key portion of the mounting element.

In an advantageous embodiment the mounting element is configured to engage pivotally with the elongated wiper arm. In this manner, the elongated wiper arm is afforded limited freedom of motion towards, and away from, the surface to be wiped.

As previously noted, the leaf spring element biases the elongated wiper arm toward the surface to be wiped. In an advantageous embodiment, a fastener couples the mounting element and the leaf spring element to the source of wiper motion, and serves to bias the elongated wiper arm toward the surface to be wiped.

In accordance with yet another aspect of the invention, there is provided a wiper arrangement for a surface. The wiper arrangement is provided with a wiper arm member that has first and second ends. In addition, a mounting arrangement is disposed on the first end of the wiper arm for coupling the first end of the wiper arm member to a source of motion. The mounting arrangement imparts a torque to the wiper arm member for urging the wiping motion, and concurrently affords a limited pivoting action for accommodating motion of the wiper arm member toward and away from the surface.

In one embodiment of this aspect of the invention, there is further provided a compliant wiper force distribution arrangement coupled to the second end of the wiper arm member. The compliant wiper force distribution arrangement has an integrally formed resilient beam member adapted to engage a wiper blade, and in an advantageous embodiment, is formed integrally with the wiper arm member.

In a further embodiment, the wiper arm member is pivotally displaceable relative to the mounting arrangement. The wiper arm member and the mounting arrangement are configured to engage one another as a hinge. Structurally, the mounting arrangement is provided with a lateral protuberance, and the wiper arm member is provided with a notch for pivotally engaging the lateral protuberance.

### BRIEF DESCRIPTION OF THE DRAWING

Comprehension of the invention is facilitated by reading the following detailed description, in conjunction with the annexed drawing, in which:

FIG. 1 is a simplified plan representation of a specific illustrative embodiment of the invention in which a wiper arm member is integrally formed with a compliant wiper force distribution arrangement;

FIG. 2 is a is a simplified plan representation of the embodiment of FIG. 1 further showing the wiper arm member mounted on a source of motion and a decorative cap installed on the wiper arm member;

FIGS. 3a to 3f are isometric representations of portions of the embodiment of FIG. 1 illustrating respective stages of assembly of the mounting of the wiper arm member to the source of motion;

FIGS. 4a to 4f are side plan representation that correspond to respectively associated ones of FIGS. 3a to 3f;

FIG. 5 is an exploded isometric representation of the specific illustrative embodiment of the invention of FIG. 1;

FIG. 6 is an enlargement of a portion of the representation of FIG. 5; and

FIG. 7 is a side plan representation of a specific illustrative embodiment of the invention of a wiper arm member that is configured to be coupled to a convention wiper arrangement.

### DETAILED DESCRIPTION

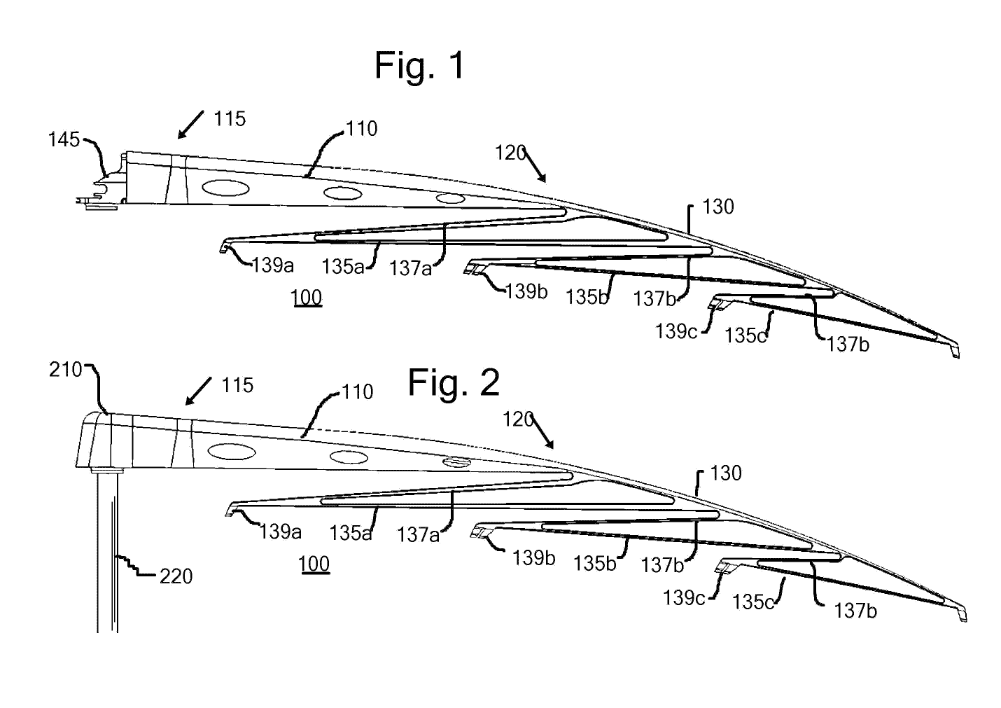

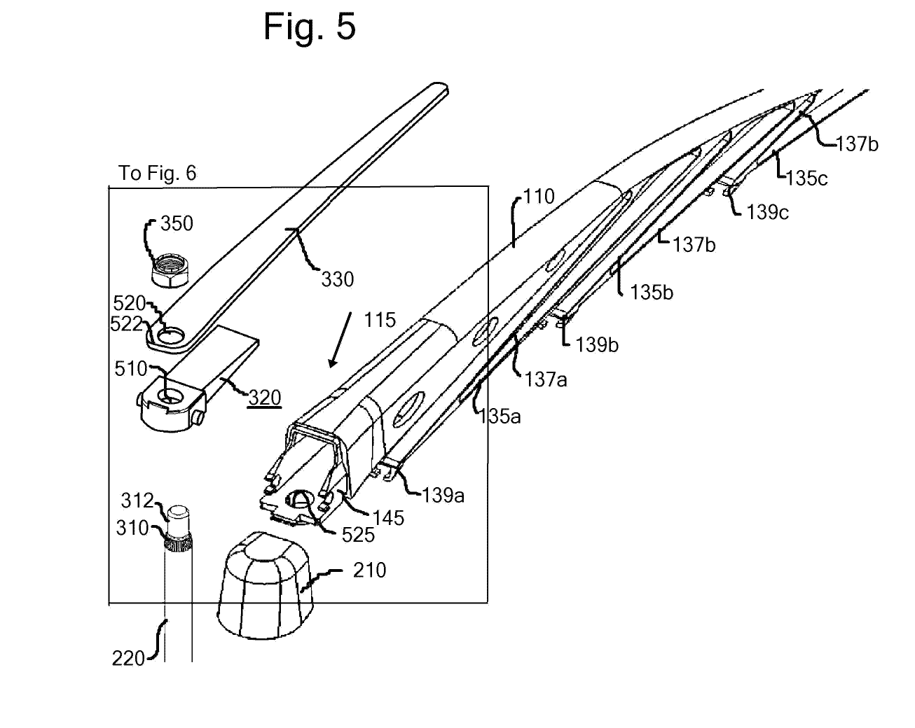

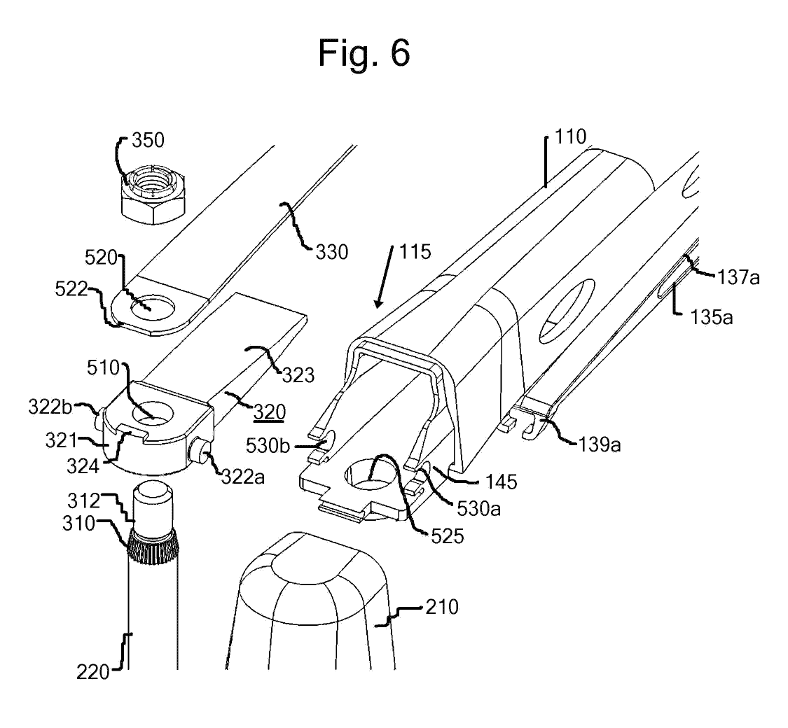

FIG. 1 is a simplified plan representation of a specific illustrative embodiment of a wiper arrangement 100 in which a wiper arm member 110 is integrally formed with a compliant wiper force distribution arrangement 130. As shown in this figure, wiper arm member 110 has a first wiper arm end 115 and a second wiper arm end 120. A mounting structure 145 is formed at first wiper arm end 115 of the wiper arm member. Mounting structure 145 will be described in greater detail below in connection with FIGS. 5 and 6.

Referring once again to FIG. 1, compliant wiper force distribution arrangement 130 is shown in this specific illustrative embodiment of the invention to be formed integrally with wiper arm member 110. Compliant wiper force distribution arrangement 130 is shown to have a plurality of first resilient beam members 135a, 135b, and 135c, and a further plurality of second resilient beam members 137a, 137b, and 137c. The first and second resilient beam members couple to respectively associated ones of wiper blade receiving terminations 139a, 139b, and 139c. The operation of compliant wiper force distribution arrangement 130 is described in U.S. Pat. No. 7,360,272, the disclosure of which is incorporated herein by reference.

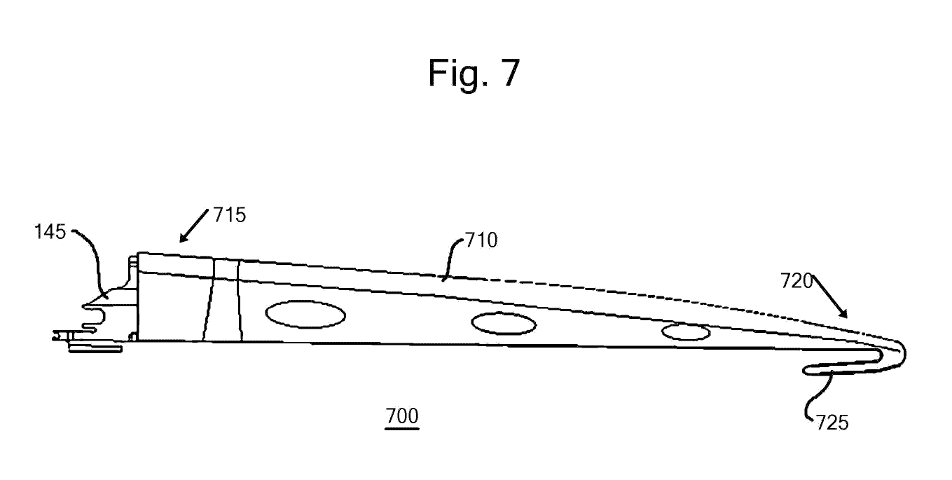

It is to be understood that the practice of the invention is not limited to the number and arrangement of first and second resilient beam members presented in the specific illustrative embodiment of the invention that has been selected herein to be described. More specifically, any number of resilient beam members can be employed in the practice of the invention, as few as one or none, depending upon the wiping application to which the invention is applied. It is further to be understood that the wiper arm member and the compliant wiper force distribution arrangement need not be formed integrally. As will be described below, particularly in connection with FIG. 7, the wiper arm member of the present invention can be used to engage with any conventional wiper blade support arrangement using a conventional form of coupler.

FIG. 2 is a is a simplified plan representation of the embodiment of FIG. 1 further showing the wiper arm member 110 mounted on a mounting post 220 and a decorative cap 210 installed on the wiper arm member. Elements of structure that have previously been discussed are similarly designated. As will be described in detail below, decorative cap 210 is provided to cover the mounting system and thereby provide an aesthetic presentation consistent with modern automotive styling.

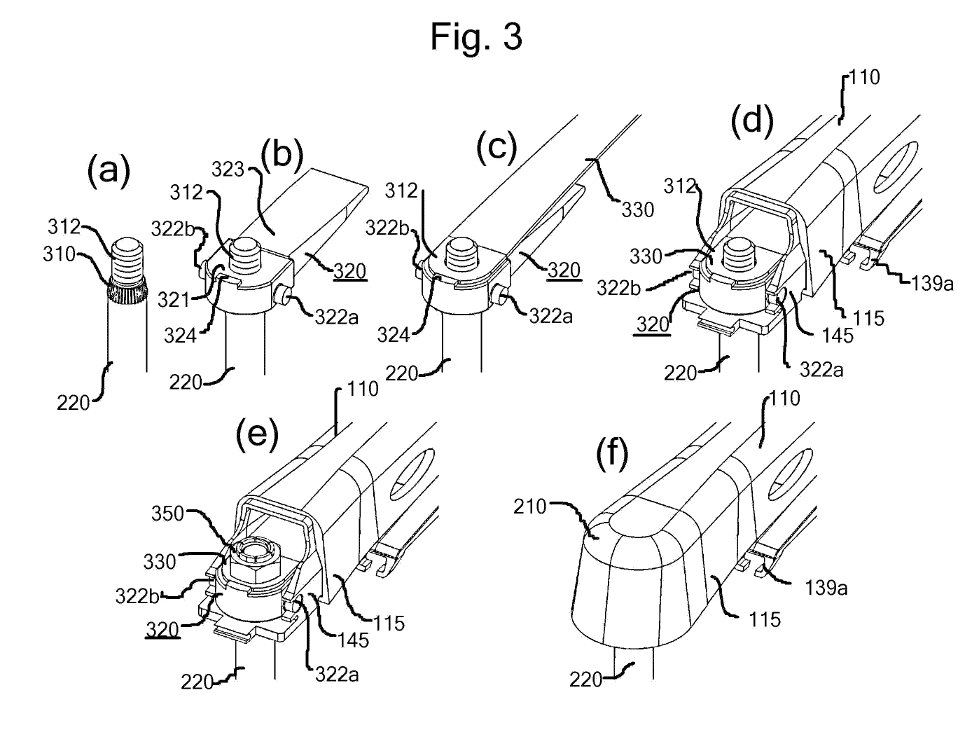

FIGS. 3a to 3f are isometric representations of portions of wiper arrangement 100 that are useful to illustrate respective stages of assembly of the mounting of the wiper arm member 110 to mounting post 220. Elements of structure that have previously been discussed are similarly designated. It is to be understood that FIGS. 3a to 3f do not represent a sequence of assembly of the wiper arrangement of the invention, and are presented solely as illustrative of the spatial relationship between the elements of structure. As shown in FIG. 3a, a source of motion, particularly of the type employed in automotive applications, is in the form of a mounting post 220 that has a coupling portion (not specifically designated) that has a splined region 310 and a threaded portion 312. As is known, mounting post 220 operates by rotating about its longitudinal axis (not specifically designated) in a cyclically reversible manner to effect the wiping motion.

FIG. 3b shows a mountable drive element that is generally designated in the figure as item 320, having a coupling portion 321 with substantially cylindrical protuberances 322a and 322b extending therefrom in opposing directions. Mountable drive element 320 additionally has an extended driving portion 323 that projects outward from coupling portion 321 in a direction transverse to substantially cylindrical protuberances 322a and 322b. Mountable drive element 320 has at coupling portion 321 an aperture (not shown in this figure) that, when installed as shown on mounting post 220, surrounds splined region 310 and in some embodiments, part of threaded portion 312. As shown, extended driving portion 323 is tapered along its axis to enable pivoting of wiper arm member 110 with respect to mounting post 220, as will be described below.

FIG. 3c shows the arrangement of FIG. 3b with the addition of a leaf spring 330 installed on mounting post 220 so as to overlie mountable drive element 320. Leaf spring 330 has an aperture therethrough (not specifically designated in this figure) that accommodates threaded portion 312 of mounting post 220. In addition, leaf spring 330 has a portion in the vicinity of the aperture that is configured to communicate with an indexing protuberance 324 that extends upwardly in the figure from coupling portion 321 of mountable drive element 320 and functions as a keyway. The communication between indexing protuberance 324 and leaf spring 330 ensures that leaf spring 330 remains substantially parallel to extended driving portion 323, as will be described below in connection with FIGS. 5 and 6.

FIG. 3d shows the arrangement of FIG. 3c with the addition of wiper arm member 110. As shown, mountable drive element 320 and leaf spring 330 engage with mounting structure 145 at first wiper arm end 115 of wiper arm member 110. The engagement between mounting structure 145 and substantially cylindrical protuberances 322a and 322b will be described below in connection with FIGS. 5 and 6.

FIG. 3e shows the arrangement of FIG. 3d with the addition of a fastener 350 that is installed threadedly on threaded portion 312 of mounting post 220. The tightening of fastener 350 urges mountable drive element 320 onto splined region 310 of mounting post 220 thereby ensuring a coupling that can transfer to wiper arm member 110 the torque that is necessary to effect the wiping motion. In this specific illustrative embodiment of the invention, fastener 350 is a locking or castle nut that, when tightened, tends to lock removably onto threaded portion 312.

FIG. 3f shows that there has been installed over mounting structure 145 decorative cap 210 that effects an aesthetically pleasing termination to the assembly.

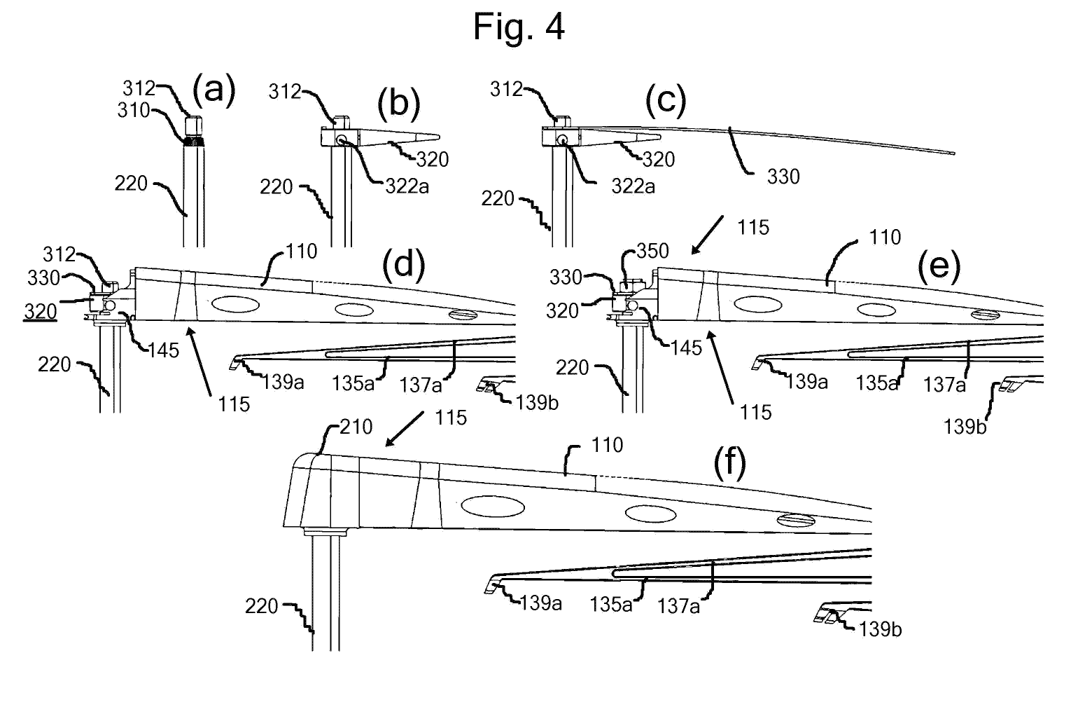

FIGS. 4a to 4f are side plan representations that correspond to respectively associated ones of the isometric representations of FIGS. 3a to 3f. Elements of structure that have previously been discussed are similarly designated.

FIG. 5 is an exploded isometric representation of the specific illustrative embodiment of the invention of FIG. 1, FIG. 6 is an enlargement of a portion of the representation of FIG. 5. Elements of structure that have previously been discussed are similarly designated. As shown in these figures, mountable drive element 320 is shown to have a mounting through aperture 510. Also, leaf spring 330 has a leaf spring through aperture 520. Mounting through aperture 510 of mountable drive element 320 and leaf spring through aperture 520 of leaf spring 330 are shown to be axially aligned with mounting post 220 and with the aperture (not specifically designated) of fastener 350. In some embodiments of the invention splined region 310 of mounting post 220 is formed of a harder material than coupling portion 321 of mountable drive element 320. Thus, when fastener 350 is tightened onto threaded portion 312 of mounting post 220, the splines splined region 310 embed themselves into the inside surface of mounting through aperture 510 of mountable drive element 320, thereby improving the transmission of torque to mountable drive element 320.

The transmission of torque from mounting post 220 to leaf spring 330 is enhanced by indexing protuberance 324 of coupling portion 321 of mountable drive element 320. Indexing protuberance 324 communicates with a flattened portion 522 of leaf spring 330.

FIGS. 5 and 6 additionally show that mounting structure 145 of wiper arm member 110 has a wiper arm member through aperture 525. When assembled, wiper arm member through aperture 525 accommodates mounting post 220 therethrough.

FIG. 6 shows that mounting structure 145 of wiper arm member 110 is provided with circular notches 530a and 530b that accommodate substantially cylindrical protuberances 322a and 322b, respectively, of coupling portion 321 of mountable drive element 320. Such coupling enables a pivoting, or hinge-like action between wiper arm member 110 and mountable drive element 320 that serves to accommodate displacement of the wiper arm member as it is urged over the contour of the surface being wiped (not shown). As previously noted, extended driving portion 323 is tapered to facilitate the pivoting or hinge-like action between wiper arm member 110 and mountable drive element 320.

In some embodiments of the invention, substantially cylindrical protuberances 322a and 322b additionally serve to impart a wiping torque to wiper arm member 110. It is to be noted that the engagement of mountable drive element 320 with splined region 310 precludes mountable drive element 320 from pressing against wiper arm member 110 at wiper arm member through aperture 525. Thus, wiper arm member 110 is, as noted above, permitted a slight pivoting motion toward and away from the surface (not shown) to be wiped, and essentially floats beneath mountable drive element 320, such flotation being limited by the engagement between substantially cylindrical protuberances 322a and 322b and circular notches 530a and 530b. Leaf spring 330, however, is firmly urged against mountable drive element 320 by the tightening of fastener 350, such tightening serving to urge leaf spring 330 in the direction toward the surface that is to be wiped.

Referring once again to wiper arm member through aperture 525, this aperture is, in this specific illustrative embodiment of the invention, not precisely round and slightly larger that the dialer of mounting post 220. The aperture is a close fit to the mounting post along the axially parallel sides of the aperture, but is slightly elongated along the axis to accommodate a slight pivoting action. In a practical embodiment of the invention, wiper arm member through aperture 525 is configured to allow wiper arm member 110 to pivot about substantially cylindrical protuberances 322a and 322b by approximately between 5° and 7°. In addition, in some embodiments, wiper arm member through aperture 525 is slightly tapered (conical) to enable such pivotal displacement.

FIG. 7 is a side plan representation of a specific illustrative embodiment of the invention of a wiper arm arrangement 700 having a wiper arm member 710 with a first end 715 and a second end 720. First end 715 has mounting structure 145 formed therewith, as previously described in connection with FIGS. 1 and 3d. In this specific illustrative embodiment of the invention, second end 720 of wiper arm member 710 is configured to have a conventional hook 725 that is configured to be coupled to a convention wiper arrangement (not shown). Thus, the wiper arm member of the present invention is not limited to the inclusion of a compliant force distribution arrangement, or to the integral formation of a compliant force distribution arrangement.

Although the invention has been described in terms of specific embodiments and applications, persons skilled in the art may, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof.

What is claimed is:

1. A wiper arrangement for a surface, the wiper arrangement comprising:
a wiper arm member having first and second ends;
a mounting arrangement disposed on the first end of said wiper arm for coupling the first end of the wiper arm member to a source of motion; and
a compliant wiper force distribution arrangement coupled to the second end of said wiper arm member and having an integrally formed resilient beam member adapted to engage a wiper blade.

2. The wiper arrangement of claim 1, wherein said wiper arm member and said compliant wiper force distribution arrangement are integrally formed.

3. The wiper arrangement of claim 1, wherein said compliant wiper force distribution arrangement is provided with a resilient beam member.

4. The wiper arrangement of claim 1, wherein said compliant wiper force distribution arrangement is provided with a plurality of resilient beam members.

5. The wiper arrangement of claim 4, wherein said plurality of resilient beam members form respective resilient triangles.

6. The wiper arrangement of claim 1, wherein said wiper arm member and said mounting arrangement are integrally formed.

7. The wiper arrangement of claim 1, wherein said mounting arrangement is pivotally coupled to said first end of said wiper arm member so as to facilitate angular translation of said wiper arm member in directions away and toward the surface.

8. The wiper arrangement of claim 7, wherein said mounting arrangement is formed of a metallic material.

9. The wiper arrangement of claim 1, wherein there is further provided a leaf spring element coupled at a first end thereof to said mounting arrangement for urging said compliant wiper force distribution arrangement in the direction of the surface.

10. The wiper arrangement of claim 9, wherein said leaf spring element engages at its first end with said mounting arrangement for urging said compliant wiper force distribution arrangement laterally across the surface.

11. The wiper arrangement of claim 9, wherein said leaf spring urges said compliant wiper force distribution arrangement in the direction of the surface with a force that had been predetermined in its magnitude in response to a resilience characteristic of said compliant wiper force distribution arrangement.

12. The wiper arrangement of claim 9, wherein the surface has a non-linear contour and said leaf spring element urges said compliant wiper force distribution arrangement in the direction of the surface with a force whereby said compliant wiper force distribution arrangement maintains contact with the non-linear contour of the surface throughout a wipe cycle.

13. The wiper arrangement of claim 9, wherein there is further provided a fastener for engaging said wiper arm member to the source of motion.

14. The wiper arrangement of claim 13, wherein said leaf spring element is biased toward the surface in response to engagement of the fastener with the source of motion.

15. The wiper arrangement of claim 9, wherein said leaf spring element is configured to be accommodated within said wiper arm member.

16. The wiper arrangement of claim 1, wherein said wiper arm member and said mounting arrangement are configured to engage one another as a hinge.

17. The wiper arrangement of claim 1, wherein said compliant wiper force distribution arrangement is configured to apply a non-uniform force to the surface.

18. wiper arrangement of claim 1, wherein the surface is a translucent surface of a vehicle.

19. A wiper arrangement for a surface, the wiper arrangement having a compliant wiper force distribution arrangement, the wiper arrangement comprising:
a wiper arm member having first and second ends, and an intermediate portion disposed between said first and second ends;
a leaf spring element for urging the compliant wiper force distribution arrangement in the direction of the surface; and
a mounting arrangement for coupling the first end of the wiper arm member and said leaf spring element to a source of motion.

20. The wiper arrangement of claim 19, wherein there is further provided a compliant wiper force distribution arrangement coupled to the second end of said wiper arm member.

21. The wiper arrangement of claim 20, wherein said compliant wiper force distribution arrangement has a plurality of resilient beam members integrally formed with each other.

22. The wiper arrangement of claim 21, wherein the plurality of resilient beam members are adapted to engage a wiper blade.

23. The wiper arrangement of claim 20, wherein said compliant wiper force distribution arrangement is integrally formed with said wiper arm member.

24. The wiper arrangement of claim 19, wherein there is further provided a decorative cover arranged to overlie first end of the wiper arm member and the source of motion.

25. A wiper mounting arrangement for a wiper having an elongated wiper arm, the wiper mounting arrangement comprising:
a mounting element having a mounting portion thereof adapted for coupling to a source of wiper motion and a drive portion for engaging the elongated wiper arm; and
a leaf spring element having a mounting portion thereof adapted for coupling to a source of wiper motion and a drive portion for engaging the elongated wiper arm.

26. The wiper mounting arrangement of claim 25, wherein said mounting element is configured to engage said leaf spring element to preclude relative motion in the direction of the wiper motion.

27. The wiper mounting arrangement of claim 26, wherein said mounting element is provided with a key portion, and said leaf spring element is provided with a key way portion, the key portion and the keyway portion engaging one another

28. The wiper mounting arrangement of claim 25, wherein said mounting element is configured to engage pivotally the elongated wiper arm, whereby the elongated wiper arm is afforded limited freedom of motion towards, and away from, a surface to be wiped.

29. The wiper mounting arrangement of claim 25, wherein said leaf spring element is configured to bias the elongated wiper arm toward a surface to be wiped.

30. The wiper mounting arrangement of claim 25, wherein there is further provided a fastener for coupling said mounting element and said leaf spring element to the source of wiper motion.

31. The wiper mounting arrangement of claim 30, wherein said leaf spring element biases the elongated wiper arm toward a surface to be wiped in response to the installation of said fastener to the source of wiper motion.

32. A wiper arrangement for a surface, the wiper arrangement comprising:
a wiper arm member having first and second ends; and
a mounting arrangement disposed on the first end of said wiper arm for coupling the first end of the wiper arm member to a source of motion, said mounting arrangement imparting a torque to said wiper arm member for urging a wiping motion, and affording a limited pivoting action for accommodating motion of said wiper arm member toward and away from the surface.

33. The wiper arrangement of claim 32, wherein there is further provided a compliant wiper force distribution arrangement coupled to the second end of said wiper arm member, said compliant wiper force distribution arrangement having an integrally formed resilient beam member adapted to engage a wiper blade.

34. The wiper arrangement of claim 33, wherein said compliant wiper force distribution arrangement is integrally formed with said wiper arm member.

35. The wiper arrangement of claim 32, wherein said wiper arm member is pivotally displaceable relative to said mounting arrangement.

36. The wiper arrangement of claim 35, wherein said wiper arm member and said mounting arrangement are configured to engage one another as a hinge.

37. The wiper arrangement of claim 36, wherein said mounting arrangement is provided with a lateral protuberance, and said wiper arm member is provided with a notch for pivotally engaging said lateral protuberance.
